(19) United States
(12) Patent Application Publication
(10) Pub. No.: US 2016/0055518 A1
(43) Pub. Date: Feb. 25, 2016

(54) SYSTEM, DEVICE AND METHOD FOR PROVIDING RECIPIENT-SELECTIVE MOBILE GIFT COUPON

(71) Applicant: SK PLANET CO., LTD., Seongnam-si, Gyeonggi-do (KR)

(72) Inventors: Hyuk Jeen AHN, Seoul (KR); Hyun Sun CHOI, Seoul (KR); Hyo Jeong CHA, Seoul (KR); Ji Yoon SHIN, Seoul (KR); Sang Kyong LEE, Seoul (KR)

(21) Appl. No.: 14/784,813

(22) PCT Filed: Jun. 23, 2014
(86) PCT No.: PCT/KR2014/005530

§ 371 Date: Oct. 15, 2015

(30) Foreign Application Priority Data
Jun. 25, 2013 (KR) 10-2013-0072761

(51) Int. Cl. G06Q 30/02

(52) U.S. Cl. CPC G06Q 30/0239

(57) ABSTRACT

A system, device and method for providing a recipient-selective mobile gift coupon, and according to one embodiment of the present invention, comprising: an order terminal device through which at least one from a gift coupon list including Moneycon, Quizcon and Choicecon is selected and inputted, and through which a payment is made on a product selected through a reception terminal device; a gift coupon provision device for providing the gift coupon list to the order terminal device, transmitting, to the reception terminal device, a gift coupon inputted by the order terminal device and transmitting, to the reception terminal device, a Gifticon matched with the product selected using the gift coupon to the reception terminal device; and the reception terminal device for selecting the product by using the gift coupon received from the gift coupon provision device, and receiving the Gifticon matched with the product.

### TECHNICAL FIELD

The present invention relates to a system, apparatus, and method for providing a recipient-selective mobile gift coupon and, more particularly, to a system, apparatus, and method, wherein when an order terminal device sends a mobile gift coupon, a reception terminal device is able to directly select a product using the mobile gift coupon and to receive a Gifticon matched with the product.

### BACKGROUND ART

As the spread of mobile devices, such as smart phones, is recently suddenly expanded and wireless communication technologies are developed, the user of a mobile device downloads a gift icon, such as an electronic coupon, and uses the gift icon when purchasing a product.

However, a conventional gift icon is matched with only a single specific product selected by an orderer and transmitted to a recipient, and thus the orderer has a limit in sending a gift icon complying with his or her purpose to the recipient.

Furthermore, a conventional gift icon providing service adopts only a method in which an orderer one-sidedly sends the gift icon of a product that has been directly selected by the orderer to a recipient without taking into consideration the taste or preference of the recipient. Accordingly, the recipient could not be provided with a gift more suitable for the recipient.

Furthermore, if a company provides gift icons for a marketing purpose, such as the promotion of a new product, the creation of new customers, or the management of existing customers, there was a problem in that a marketing effect is reduced because there is no scheme capable of incorporating the interests, tastes, and ages of target customers.

Furthermore, there are problems in that a recipient is not provided with an opportunity to select a product suitable for the recipient, the recipient's attention or interest in the corresponding product is inevitably reduced, and the recipient does not properly use a previously received gift icon because the recipient one-sidedly receives the gift icon from an orderer.

### DISCLOSURE

### Technical Problem

An object of the present invention is to provide a variety of types of mobile gift coupons so that an orderer can select a mobile gift coupon complying with his or her purpose and send the selected mobile gift coupon to a recipient.

Furthermore, an object of the present invention is to enable a recipient to be provided with a gift more suitable for him or her by selecting a product according to the recipient's taste or preference using a mobile gift coupon and receiving a Gifticon matched with the product.

Furthermore, an object of the present invention is to maximize a marketing effect in such a manner that a company provides a customer with an opportunity to directly select a product according to the customer's interest, taste, and age.

Furthermore, an object of the present invention is to induce a recipient's attention or interest and to increase the utilization of a gift icon because the recipient can actively select a product using a mobile gift coupon.

### Technical Solution

An apparatus 300 for providing a recipient-selective mobile gift coupon in accordance with an embodiment of the present invention for solving the objects includes a gift coupon management unit 310 which provides a gift coupon list to an order terminal device 100 and sends a gift coupon inputted by the order terminal device 100 to a reception terminal device 200, a product information provision unit 320 which sends a product list or product information to the reception terminal device 200 or the order terminal device 100, a customer management unit 330 which stores and manages customer information including the unique number, account number, access history, and transaction history of the order terminal device 100 and the reception terminal device 200, a settlement processing unit 340 which provides the order terminal device 100 with a web page for payment for a product selected by the reception terminal device 200 using the gift coupon and checks whether the settlement has been completed, a Gifticon provision unit 350 which sends a Gifticon matched with the selected product to the reception terminal device 200 when the payment for the selected product is completed and manages whether the Gifticon has been received and has been used while operating in conjunction with the customer management unit 330, and a control unit which controls the operations of the gift coupon management unit 310, the product information provision unit 320, the customer management unit 330, the settlement processing unit 340, and the Gifticon provision unit 350.

In an embodiment of the present invention, if the gift coupon inputted by the order terminal device 100 is a Moneycon, the gift coupon management unit 310 may provide the limit amount input window with the order terminal device 100, may set the limit amount of money inputted by the order terminal device 100 in the Moneycon, and may send the Moneycon to the reception terminal device 200. In this case, the order terminal device 100 may also input a product range along with the limit amount of money. In this case, the product information provision unit 320 may preferably send a product list that may be purchased using the Moneycon to the reception terminal device 200. Furthermore, the settlement processing unit 340 may receive account information from the order terminal device 100 before the reception terminal device 200 selects the product using the gift coupon, may perform settlement on the limit amount of money, and may return a difference between the limit amount of money and the selected product to the account of the order terminal device 100 after the reception terminal device 200 selects the product using the gift coupon.

In another embodiment of the present invention, the gift coupon management unit 310 may provide a quiz setting window and the product list to the order terminal device 100, if the gift coupon inputted by the order terminal device 100 is a Quizcon, and may set quiz setting information in the Quizcon when the quiz setting information including a quiz, questionnaires, and products matched with the respective questionnaires in the quiz setting window is received from the order terminal device 100. In this case, when any one of the questionnaire is selected by the reception terminal device 200, the product information provision unit 320 may preferably send product information matched with the selected questionnaire to the reception terminal device 200. Furthermore, the settlement processing unit 340 may receive account information from the order terminal device 100, may perform settlement on the highest price product of the products matched with the respective questionnaires, before the reception terminal device 200 selects the product using the gift coupon. The reception terminal device 200 may select the product using the gift coupon and return a difference between the highest price product and the selected product to the account of the order terminal device 100.

In accordance with yet another embodiment of the present invention, if the gift coupon inputted by the order terminal device 100 is a Choicecon, the gift coupon management unit 310 may provide a product list to the order terminal device 100, may receive two or more products from the order terminal device 100, may set the two or more products in the Choicecon, and may select any one of the products set in the Choicecon and selected by the reception terminal device 200. In this case, the settlement processing unit 340 may receive account information from the order terminal device 100 before the reception terminal device 200 selects the product using the gift coupon, may perform settlement on the highest price product of the two or more products, and may return a difference between the highest price product and the selected product to the account of the order terminal device 100 after the reception terminal device 200 selects the product using the gift coupon.

Meanwhile, a system for providing a recipient-selective mobile gift coupon in accordance with an embodiment of the present invention may include an order terminal device 100 which selects and inputs at least any one of a Moneycon, a Quizcon, and a Choicecon included in a gift coupon list and performs settlement on a product selected by a reception terminal device 200, a gift coupon provision apparatus which provides the gift coupon list to the order terminal device 100, sends a gift coupon inputted by the order terminal device 100 to the reception terminal device 200, and sends a Gifticon matched with the product selected by the reception terminal device 200 using the gift coupon to the reception terminal device 200, and the reception terminal device 200 which selects the product using the gift coupon received from the gift coupon provision apparatus and receives the Gifticon matched with the selected product.

If the gift coupon inputted by the order terminal device 100 is the Moneycon, the gift coupon provision apparatus may provide the limit amount input window to the order terminal device 100, may set the limit amount of money inputted by the order terminal device 100 in the Moneycon, and may send a product list that may be purchased using the Moneycon to the reception terminal device 200. Furthermore, if the gift coupon inputted by the order terminal device 100 is the Quizcon, the gift coupon provision apparatus may provide a quiz setting window and the product list to the order terminal device 100, may set quiz setting information in the Quizcon when the order terminal device 100 inputs the quiz setting information, including a quiz, questionnaires, and products matched with the respective questionnaires, to the quiz setting window, and may send product information matched with a selected questionnaire to the reception terminal device 200 when any one of the questionnaires is selected by the reception terminal device 200. Furthermore, if the gift coupon inputted by the order terminal device 100 is the Choicecon, the gift coupon provision apparatus may provide a product list to the order terminal device 100, may receive two or more products from the order terminal device 100, and may set the two or more products in the Choicecon.

Meanwhile, a method for providing a recipient-selective mobile gift coupon may include steps of (a) providing, by a gift coupon provision apparatus, an order terminal device 100 with a gift coupon list including a Moneycon, a Quizcon, and a Choicecon, (b) receiving at least any one gift coupon of the gift coupon list from the order terminal device 100, (c) sending, by the gift coupon provision apparatus, the selected gift coupon, to a reception terminal device 200, (d) receive a product selected by the reception terminal device 200 using the gift coupon, and (e) sending, by the gift coupon provision apparatus, a Gifticon matched with the selected product to the reception terminal device 200.

In this case, the step (b) may further include a step of providing, by the gift coupon provision apparatus, the limit amount input window to the order terminal device 100 when the Moneycon is inputted, receiving the limit amount of money, and setting the limit amount of money in the Moneycon. The step (d) may include steps of providing, by the gift coupon provision apparatus, the reception terminal device 200 with a product list corresponding to the limit amount of money set in the Moneycon and selecting, by the reception terminal device 200, a product in the product list. In this case, the method may further include a step of receiving account information from the order terminal device 100 and performing settlement on the limit amount of money prior to the step (d) and a step of returning a difference between the limit amount of money and the product selected by the reception terminal device 200 to the account of the order terminal device 100 after the step (d).

Furthermore, in accordance with yet another embodiment of the present invention, the step (b) may further include a step of providing the order terminal device 100 with a quiz setting window and the product list if the Quizcon is inputted and setting quiz setting information in the Quizcon if the order terminal device 100 inputs the quiz setting information, including a quiz, questionnaires, and products matched with the respective questionnaires, to the quiz setting window. The step (d) may include steps of receiving any one of the questionnaires from the reception terminal device 200 and sending, by the gift coupon provision apparatus, product information matched with the selected questionnaire to the reception terminal device 200. In this case, the method may further include a step of receiving account information from the order terminal device 100 and performing settlement on the highest price product of products matched with the respective questionnaires prior to the step (d) and may further include returning a difference between the highest price product and the product selected by the reception terminal device 200 to the account of the order terminal device 100 after the step (d).

Furthermore, in accordance with yet another embodiment of the present invention, the step (b) may further include a step of providing, by the gift coupon provision apparatus, a product list to the order terminal device 100 if a Choicecon is selected, receiving two or more products, and setting the two or more products in the Choicecon. The step (d) may include receiving one of the products set in the Choicecon from the reception terminal device 200. In this case, The method may further include steps of receiving account information from the order terminal device 100 and performing settlement on the highest price product of the two or more products prior to the step (d), and returning a difference between the highest price product and the product inputted by the reception terminal device 200 to the account of the order terminal device 100 after the step (d).

### Advantageous Effects

In accordance with an aspect of the present invention for solving the objects, since a variety of types of mobile gift coupons can be provided, an orderer can select a mobile gift coupon complying with his or her purpose and send the selected mobile gift coupon to a recipient.

Furthermore, according to the present invention, a recipient can be provided with a gift more suitable for him or her because the recipient can select a product according to his or her taste or preference using a mobile gift coupon and receive a Gifticon matched with the product.

Furthermore, a marketing effect can be maximized because a company provides a customer with an opportunity to directly select a product according to the customer's interest, taste, and age.

Furthermore, a recipient's attention or interest in a corresponding service can be enhanced and the utilization of a gift icon can be increased because the recipient can actively select a product using a mobile gift coupon.

### DESCRIPTION OF DRAWINGS

FIG. 1 is a schematic configuration of a system and apparatus for providing a recipient-selective mobile gift coupon in accordance with an embodiment of the present invention.

FIG. 2 is a flowchart illustrating a method for providing a recipient-selective mobile gift coupon in accordance with an embodiment of the present invention.

FIG. 3 is a flowchart illustrating a method for providing a recipient-selective mobile gift coupon if a Moneycon has been inputted in accordance with an embodiment of the present invention.

FIG. 4 is a flowchart illustrating a method for providing a recipient-selective mobile gift coupon if a Quizcon has been inputted in accordance with an embodiment of the present invention.

FIG. 5 is a flowchart illustrating a method for providing a recipient-selective mobile gift coupon if a Choicecon has been inputted in accordance with an embodiment of the present invention.

FIG. 6 is a flowchart illustrating a method for providing a recipient-selective mobile gift coupon in accordance with another embodiment of the present invention.

FIG. 7 is a diagram illustrating an example in which the limit amount of money is set if the Moneycon has been inputted in accordance with an embodiment of the present invention.

FIG. 8 is a diagram illustrating an example in which quiz setting information is inputted if a Quizcon has been inputted in accordance with an embodiment of the present invention.

FIG. 9 is a diagram illustrating an example in which a product is received from an order terminal device if a Choicecon has been inputted in accordance with an embodiment of the present invention.

### DESCRIPTION OF REFERENCE NUMERALS

100: order terminal device 200: reception terminal device
300: gift coupon provision apparatus
310: gift coupon management unit
320: product information provision unit
330: customer management unit
340: settlement processing unit
350: Gifticon provision unit
360: control unit

### MODE FOR INVENTION

Embodiments disclosed in this specification should not be interpreted or used as limiting the scope of the present invention. It is evident to those skilled in the art that a description including the embodiments of this specification has various applications. Accordingly, specific embodiments are illustrative for a better description of the present invention unless they are limited by the claims, and the scope of the present invention is not intended to be limited to the embodiments. Furthermore, in describing the present invention, a detailed description of the known functions and constitutions will be omitted if it is deemed to make the gist of the present invention unnecessarily vague.

Embodiments of the present invention are described in more detail with reference to the accompanying drawings.

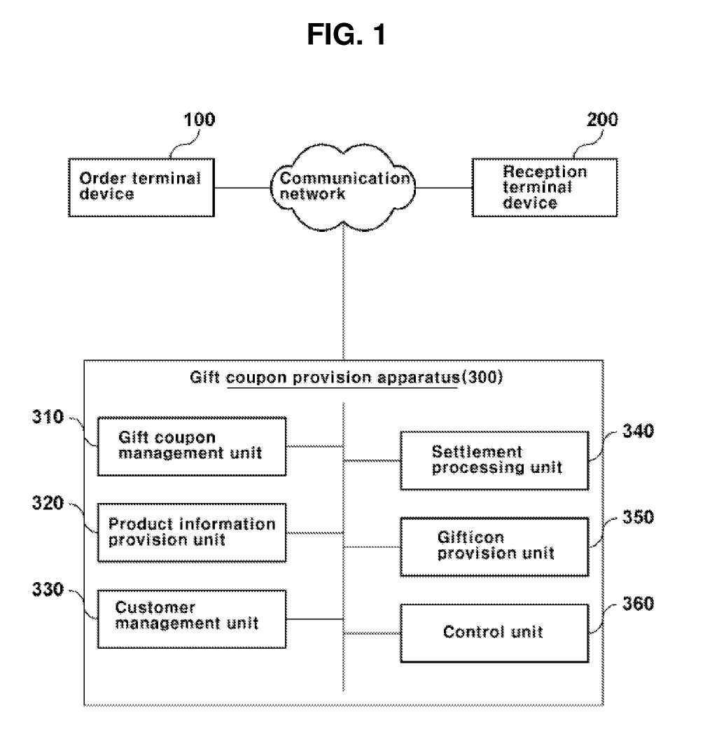

FIG. 1 is a schematic configuration of a system and apparatus for providing a recipient-selective mobile gift coupon in accordance with an embodiment of the present invention.

Referring to FIG. 1, the apparatus 300 for providing a recipient-selective mobile gift coupon in accordance with an embodiment of the present invention includes a gift coupon management unit 310 which provides a gift coupon list to an order terminal device 100 and sends a gift coupon inputted by the order terminal device 100 to a reception terminal device 200, a product information provision unit 320 which sends product list or product information to the reception terminal device 200 or the order terminal device 100, a customer management unit 330 which stores and manages customer information including the unique number, account number, access history, and transaction history of the order terminal device 100 and the reception terminal device 200, a settlement processing unit 340 which provides the order terminal device 100 with a web page for payment for a product selected by the reception terminal device 200 using the gift coupon and checks whether the settlement has been completed, a Gifticon provision unit 350 which sends a Gifticon matched with a selected product to the reception terminal device 200 when the payment for the selected product is completed and manages whether the Gifticon has been received and has been used while operating in conjunction with the customer management unit, and a control unit 360 which controls the operations of the gift coupon management unit 310, the product information provision unit 320, the customer management unit, the settlement processing unit 340, and the Gifticon provision unit.

The gift coupon management unit 310 is an element which provides the order terminal device 100 with a gift coupon list and sends a gift coupon, inputted by the order terminal device 100, to the reception terminal device 200. Furthermore, the gift coupon and the Gifticon may be transmitted to the reception terminal device 200 using various methods, including messenger service, SNS, and an Open API, such as a push message and KakaoTalk, through short message service (SMS), uniform resource locator short message service (URL-SMS), multi-media message service (MMS), e-mail, and an application. Meanwhile, the gift coupon includes a Moneycon, a Quizcon, and a Choicecon. The Moneycon is a type of gift coupon in which the limit amount of money has been set. The Quizcon is a type of gift coupon in which quiz setting information including a quiz, questionnaires, and a product matched with each questionnaire has been set. The Choicecon is a type of gift coupon in which two or more products have been set so that the reception terminal device 200 can select a product.

Furthermore, the customer management unit 330 is an element which stores and manages customer information, including the unique number, account number, access history, and transaction history of each of the order terminal device 100 and the reception terminal device 200. The unique number may include all types of information capable of identifying a user, such as a telephone number, an e-mail address, an SNS account, and a password.

Furthermore, the settlement processing unit 340 may perform settlement before or after the reception terminal device 200 selects a product using the gift coupon.

Furthermore, the Gifticon provision unit 350 is an element which sends a Gifticon, matched with a product, to the reception terminal device 200 when the product is selected by the reception terminal device 200 and manages whether the Gifticon has been received and has been used while operating in conjunction with the customer management unit 330. Accordingly, if the reception terminal device 200 has not received a Gifticon due to a transmission error, the Gifticon provision unit 350 sends the Gifticon again. Furthermore, the Gifticon provision unit 350 prevents a redundant use by checking whether a Gifticon has been used in the reception terminal device 200.

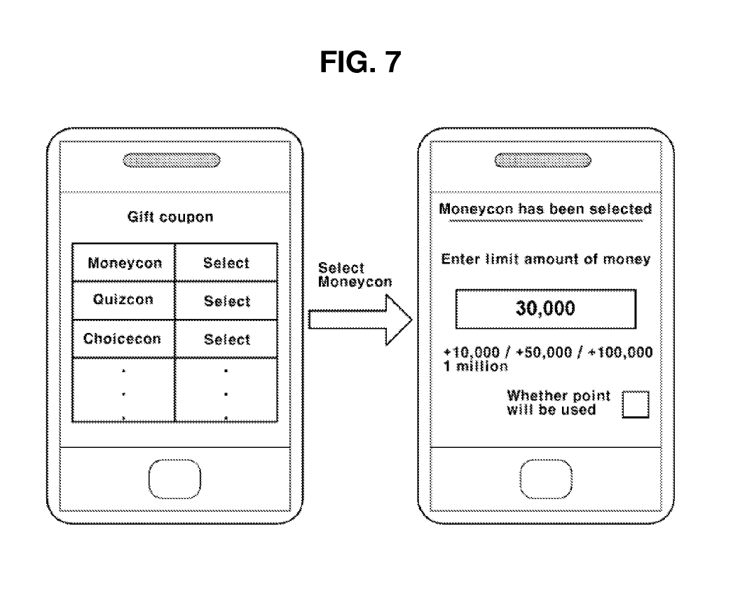

FIG. 7 is a diagram illustrating an example in which the limit amount of money is set if a Moneycon has been inputted in accordance with an embodiment of the present invention.

If a gift coupon inputted by the order terminal device 100 is a Moneycon, the gift coupon management unit 310 may provide the order terminal device 100 with a limit amount input window, may set the limit amount of money inputted by the order terminal device 100 as the Moneycon, and may sent the Moneycon to the reception terminal device 200. In this case, the order terminal device 100 may input even a product range along with the limit amount of money. For example, referring to FIG. 7, when the limit amount input window is displayed on the order terminal device 100 and the order terminal device 100 inputs 30,000 won as the limit amount of money, the gift coupon management unit 310 sets 30,000 won in the Moneycon and sends the Moneycon to the reception terminal device 200. In this case, the product information provision unit 320 preferably sends a product list that may be purchased using the Moneycon to the reception terminal device 200. Furthermore, if the order terminal device 100 has inputted even a product range along with the limit amount of money, a product list that may be purchased using the Moneycon is limited to the product range. Furthermore, the settlement processing unit 340 may receive account information from the order terminal device 100 before the reception terminal device 200 selects a product using the gift coupon, may perform settlement on the limit amount of money, may return the difference between the limit amount of money and the selected product to the account of the order terminal device 100 after the reception terminal device 200 selects a product using the gift coupon. For example, if the limit amount of money is 100,000 won and the price of the selected product is 80,000 won, 20,000 won, that is, the difference between 100,000 won and 80,000 won, is returned to the user account of the order terminal device 100. Furthermore, the settlement processing unit 340 may perform settlement after the reception terminal device 200 selects a product using the gift coupon. Meanwhile, in performing the settlement, various methods, such as common settlement and point settlement, may be used.

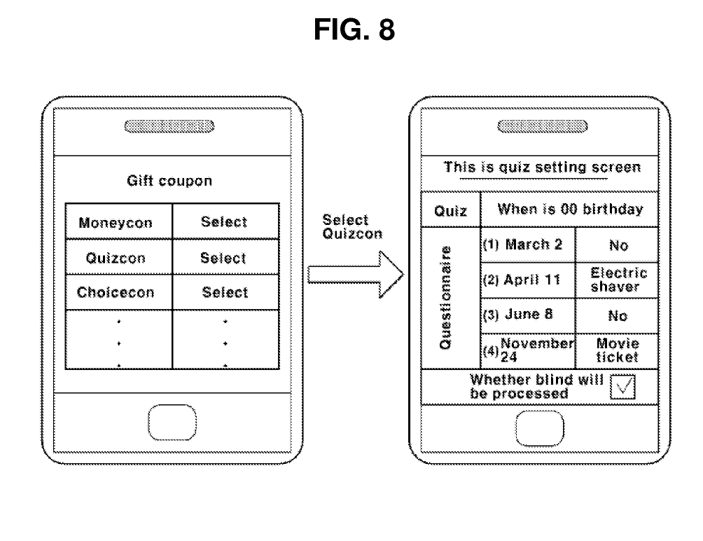

FIG. 8 is a diagram illustrating an example in which quiz setting information is inputted if a Quizcon has been inputted in accordance with an embodiment of the present invention.

In an embodiment of the present invention, if a gift coupon inputted by the order terminal device 100 is a Quizcon, referring to FIG. 8, the gift coupon management unit 310 provides a quiz setting window and the product list to the order terminal device 100. If quiz setting information including a quiz, questionnaires, and a product matched with each questionnaire in the quiz setting window is received from the order terminal device 100, the gift coupon management unit 310 may set the quiz setting information in the Quizcon. Furthermore, information about the product matched with each questionnaire may preferably be subject to blind processing and transmitted to the reception terminal device 200. In this case, when any one of the questionnaires is selected by the reception terminal device 200, the product information provision unit 320 may preferably send product information matched with the selected questionnaire to the reception terminal device 200 so that information about the product is made public to a user. Furthermore, the settlement processing unit 340 may receive account information from the order terminal device 100 before the reception terminal device 200 selects a product using the gift coupon, may perform settlement on the highest price product of products matched with the respective questionnaires, and may return the difference between the highest price product and a selected product to the account of the order terminal device 100 after the reception terminal device 200 selects the product using the gift coupon. For example, if questionnaires include four types and the amounts of products matched with the respective questionnaires are 10,000 won, 20,000 won, 30,000 won, and 40,000 won, the settlement processing unit 340 performs settlement on 40,000 won, that is, the highest price, and returns 10,000 won, that is, the difference if a product selected by the reception terminal device 200 and matched with one of the questionnaires is 30,000 won, to the user account of the order terminal device 100.

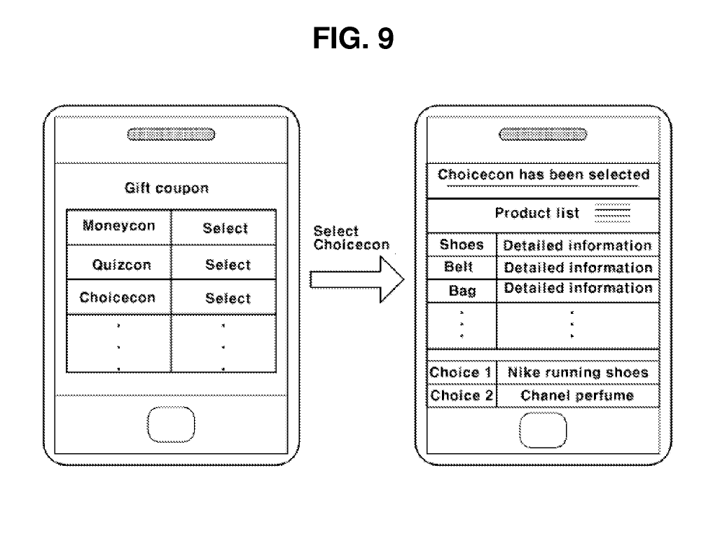

FIG. 9 is a diagram illustrating an example in which a product is received from the order terminal device if a Choicecon has been inputted in accordance with an embodiment of the present invention.

If a gift coupon inputted by the order terminal device 100 is a Choicecon, the gift coupon management unit 310 in accordance with an embodiment of the present invention may provide the order terminal device 100 with a product list, may receive two or more products from the order terminal device 100, may set the two or more products in the Choicecon, may send the Choicecon to the reception terminal device 200, and may receive any one product that belong to the products set in the Choicecon and that has been selected by the reception terminal device. For example, as illustrated in FIG. 9, when the order terminal device 100 selects two products in a product list and inputs the two products as a choice 1 and a choice 2, Nike running shoes corresponding to the choice 1 and a Chanel perfume corresponding to the choice 2 are set in the Choicecon, and any one of the Nike running shoes and the Chanel perfume is selected by the user of the reception terminal device 200. In this case, the settlement processing unit 340 may receive account information from the order terminal device 100 before the reception terminal device 200 selects a product using the gift coupon, may perform settlement on the highest price product of two or more products, and may return the difference between the highest price product and the selected product to the account of the order terminal device 100 after the reception terminal device 200 selects the product using the gift coupon. For example, if the prices of products selected by the order terminal device 100 in a product list are 50,000 won and 70,000 won, the settlement processing unit 340 performs settlement on 70,000 won, that is, the highest price. If the price of a product selected by the reception terminal device 200 is 50,000 won, 20,000 won, that is, the difference between 70,000 won and 50,000 won, is returned to the user account of the order terminal device 100.

As illustrated in FIG. 1, the system for providing a recipient-selective mobile gift coupon in accordance with an embodiment of the present invention may include the order terminal device 100 which selects and input at least any one of the Moneycon, the Quizcon, and the Choicecon included in a gift coupon list and performs settlement a product selected by the reception terminal device 200, the gift coupon provision apparatus 300 which provides the order terminal device 100 with a gift coupon list, sends a gift coupon inputted by the order terminal device 100 to the reception terminal device 200, and sends a Gifticon matched with a product selected by the reception terminal device 200 using the gift coupon to the reception terminal device 200, and the reception terminal device 200 which selects the product using the gift coupon received from the gift coupon provision apparatus 300 and receives the Gifticon matched with the selected product. Meanwhile, the order terminal device and the reception terminal device should be interpreted as including all devices having a function capable of sending and receiving data over wired/wireless communication networks, such as mobile phones, smart phones, tablet PCs, notebooks, and PDAs.

Referring to FIGS. 7 to 9, if a gift coupon inputted by the order terminal device 100 is a Moneycon, the gift coupon provision apparatus 300 may provide the order terminal device 100 with a limit amount input window, may set the limit amount of money received from the order terminal device 100 in the Moneycon, and may send a product list that may be purchased using the Moneycon to the reception terminal device 200. Furthermore, if a gift coupon inputted by the order terminal device 100 is a Quizcon, the order terminal device 100 provides a quiz setting window and the product list. If the order terminal device 100 inputs quiz setting information, including a quiz, questionnaires, and products matched with the respective questionnaires, to the quiz setting window, the order terminal device 100 sets the quiz setting information in the Quizcon. In this case, information about a product matched with each questionnaire may preferably be subject to blind processing and transmitted to the reception terminal device 200. If any one of the questionnaires is selected by the reception terminal device 200, product information matched with the selected questionnaire may be transmitted to the reception terminal device 200 so that a user can check the product information. Furthermore, if a gift coupon inputted by the order terminal device 100 is a Choicecon, a product list may be provided to the order terminal device 100, and two or more products may be inputted by the order terminal device and set in the Choicecon.

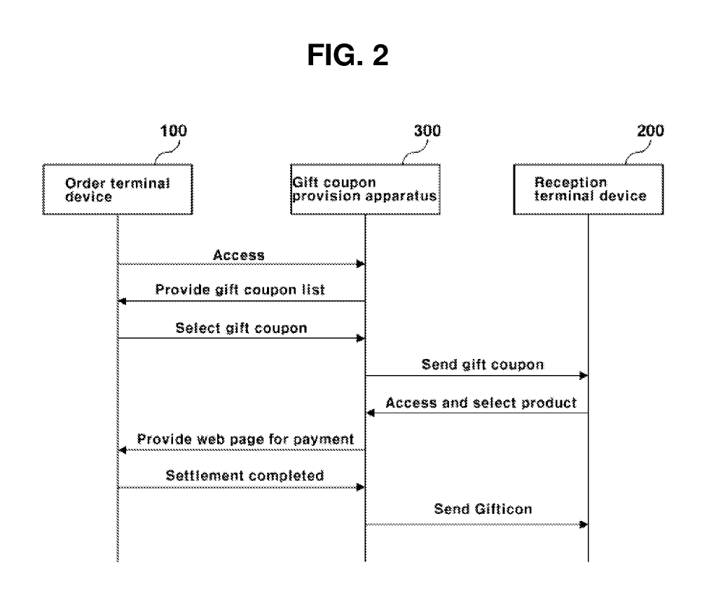

FIG. 2 is a flowchart illustrating a method for providing a recipient-selective mobile gift coupon in accordance with an embodiment of the present invention.

Referring to FIG. 2, the method for providing a recipient-selective mobile gift coupon in accordance with another embodiment of the present invention may include steps of (a) providing, by the gift coupon provision apparatus 300, the order terminal device 100 with a gift coupon list including a Moneycon, a Quizcon, and a Choicecon, (b) receiving at least any one gift coupon of the gift coupon list from the order terminal device 100, (c) sending, by the gift coupon provision apparatus 300, the selected gift coupon, to the reception terminal device 200, (d) receive a product selected by the reception terminal device 200 using the gift coupon, and (e) sending, by the gift coupon provision apparatus 300, a Gifticon matched with the selected product to the reception terminal device 200. Meanwhile, referring to FIG. 2, only an example in which settlement is performed after a product is selected by the reception terminal device 200 has been illustrated, but settlement may be performed in any one of the steps (a) to (e). Furthermore, in the steps (a), (c), and (e), the mobile gift coupon or the Gifticon may be transmitted to the order terminal device 100 or the reception terminal device 200 using various methods, including short message service (SMS), uniform resource locator short message service (URL-SMS), multi-media message service (MMS), e-mail, and an application.

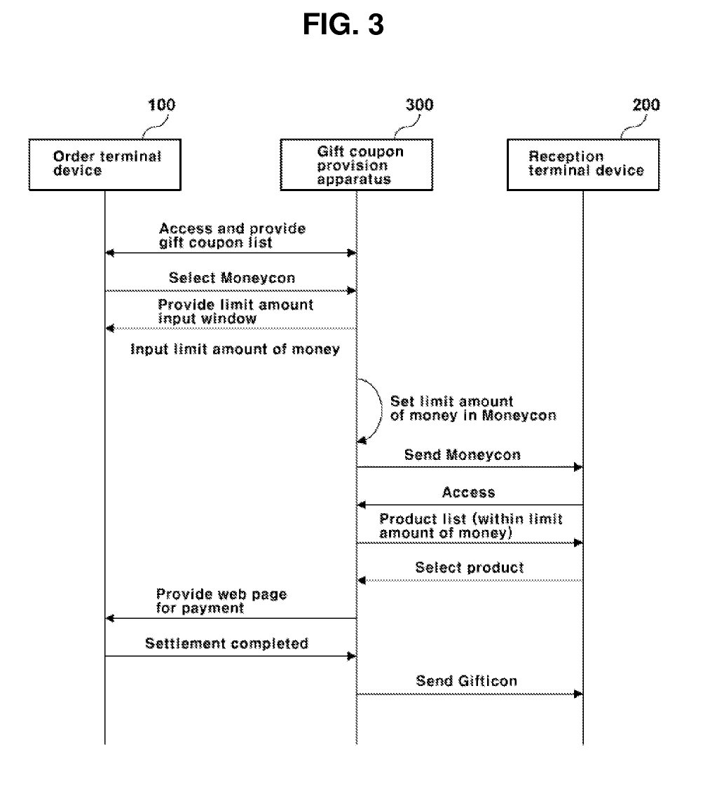

FIG. 3 is a flowchart illustrating a method for providing a recipient-selective mobile gift coupon if a Moneycon has been inputted in accordance with an embodiment of the present invention.

In this case, the step (b) may further include step of, if a Moneycon is inputted, providing, by the gift coupon provision apparatus 300, a limit amount input window to the order terminal device 100, receiving the limit amount of money, and setting the limit amount of money in the Moneycon. The step (d) may include step of providing, by the gift coupon provision apparatus 300, the reception terminal device 200 with a product list corresponding to the limit amount of money set in the Moneycon and step of selecting, by the reception terminal device 200, a product in the product list. In this case, prior to the step (d), a step of receiving account information from the order terminal device 100 and performing settlement on the limit amount of money may be further included. After the step (d), a step of returning the difference between the limit amount of money and the product selected by the reception terminal device 200 to the account of the order terminal device 100 may be further included.

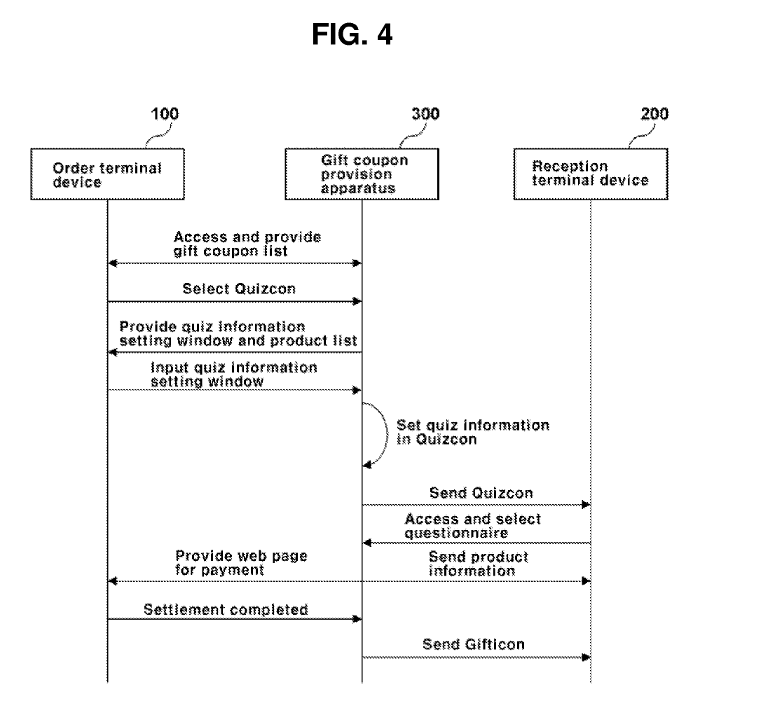

FIG. 4 is a flowchart illustrating a method for providing a recipient-selective mobile gift coupon if the Quizcon has been inputted in accordance with an embodiment of the present invention.

The step (b) may further include step of providing the order terminal device 100 with a quiz setting window and the product list if a Quizcon is inputted and setting quiz setting information in the Quizcon if the quiz setting information including a quiz, questionnaires, and products matched with the respective questionnaires is inputted to the quiz setting window by the order terminal device 100. The step (d) may include steps of receiving any one of the questionnaires from the reception terminal device 200 and sending, by the gift coupon provision apparatus 300, product information matched with the selected questionnaire to the reception terminal device 200. In the step (c), information about a product matched with each questionnaire preferably is subject to blind processing and transmitted to the reception terminal device 200. Furthermore, prior to the step (d), a step of receiving account information from the order terminal device 100 and performing settlement on the highest price product of products matched with the respective questionnaires is further included. After the step (d), a step of returning the difference between the highest price product and the product selected by the reception terminal device 200 to the account of the order terminal device 100 may be further included.

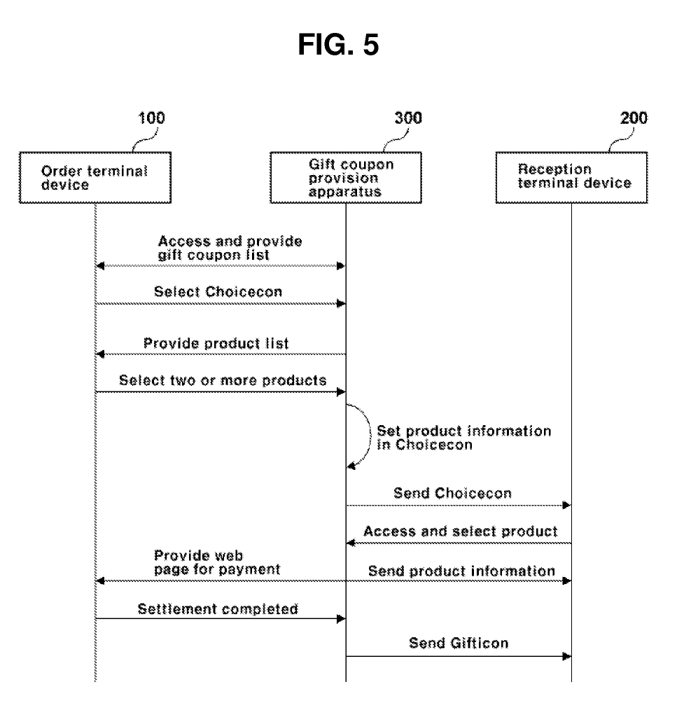

FIG. 5 is a flowchart illustrating a method for providing a recipient-selective mobile gift coupon if a Choicecon has been inputted in accordance with an embodiment of the present invention.

Referring to FIG. 5, the step (b) may further include a step of providing, by the gift coupon provision apparatus 300, a product list to the order terminal device 100 when a Choicecon is selected, receiving two or more products, and setting the two or more products in the Choicecon. The step (d) may include receiving one of the products set in the Choicecon from the reception terminal device 200. In this case, prior to the step (d), a step of receiving account information from the order terminal device 100 and performing settlement on the highest price product of the two or more products may be further included. After the step (d), a step of returning the difference between the highest price product and the product inputted by the reception terminal device 200 to the account of the order terminal device 100 may be further included.

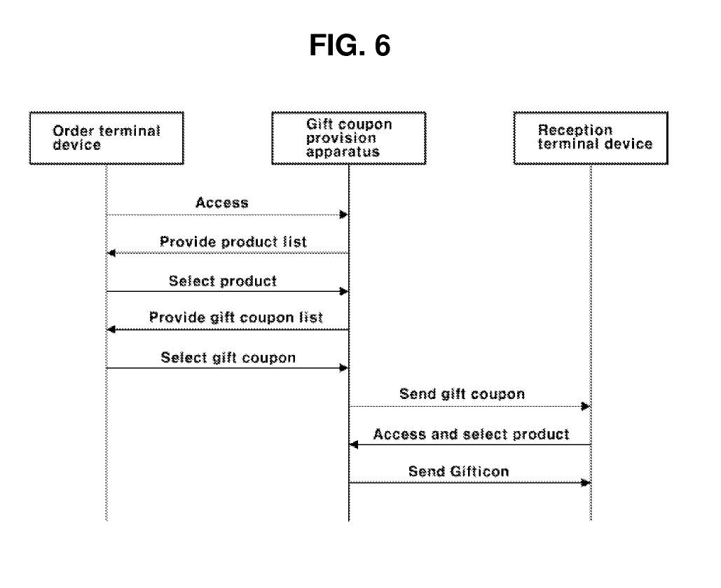

Meanwhile, referring to FIG. 6, the method for providing a recipient-selective mobile gift coupon in accordance with yet another embodiment of the present invention further includes a step of receiving, by the order terminal device, a product list from the gift coupon provision apparatus prior to the step (a) and selecting at least one product in the product list. The step (b) may include steps of setting, by the order terminal device, information about one or more products selected from the product list in at least one gift coupon of the gift coupon list and receiving, by the gift coupon provision apparatus, a gift coupon in which information about the products has been set from the order terminal device. That is, an orderer may select one or more products in a product list after selecting at least one gift coupon in a gift coupon list using the order terminal device, and may set the one or more products in at least one gift coupon of the gift coupon list after selecting the one or more products in the product list. For example, after an orderer selects one gift coupon in a gift coupon list using the order terminal device, the orderer may select products, such as running shoes and cosmetics, and set the selected products in the gift coupon. After an orderer selects products, such as running shoes and cosmetics, the orderer may select one gift coupon in a gift coupon list and set information about the products. In this case, when the reception terminal device 200 selects products using the gift coupon in the step (d), it may select some products within a range of products selected by the order terminal device.

Meanwhile, referring to FIGS. 3 to 5, only an example in which the order terminal device 100 performs settlement after a product is selected by the reception terminal device 200 has been illustrated, but the settlement may be performed in any one of the steps (a) to (e).

Unless explicitly described to the contrary, the word, such as “include”, will be understood to imply the inclusion of a stated element but not the exclusion of any other elements and may further include other elements.

The aforementioned embodiments of the present invention have been disclosed for illustrative purposes, and the present invention is not restricted by the embodiments. Furthermore, those skilled in the art to which the present invention pertains may modify and change the present invention in various ways within the spirit and scope of the present invention, and such modifications and changes should be construed as belonging to the scope of the present invention.

### INDUSTRIAL APPLICABILITY

The present invention may be used to provide a system, apparatus, and method for providing a recipient-selective mobile gift coupon, wherein when an order terminal device selects a mobile gift coupon complying with its purpose and sends the selected mobile gift coupon to a reception terminal device, the user of the reception terminal device can directly select a product suitable for him or her using the mobile gift coupon.

1. An apparatus for providing a recipient-selective mobile gift coupon, comprising:
a gift coupon management unit which provides a gift coupon list to an order terminal device and sends a gift coupon inputted by the order terminal device to a reception terminal device;
a product information provision unit which sends a product list or product information to the reception terminal device or the order terminal device;
a customer management unit which stores and manages customer information comprising a unique number, account number, access history, and transaction history of the order terminal device and the reception terminal device;
a settlement processing unit which provides the order terminal device with a web page for payment for a product selected by the reception terminal device using the gift coupon and checks whether the settlement has been completed;
a Gifticon provision unit which sends a Gifticon matched with the selected product to the reception terminal device when the payment for the selected product is completed and manages whether the Gifticon has been received and has been used while operating in conjunction with the customer management unit; and
a control unit which controls operations of the gift coupon management unit, the product information provision unit, the customer management unit, the settlement processing unit, and the Gifticon provision unit.

2. The apparatus of claim 1, wherein if the gift coupon inputted by the order terminal device is a Moneycon, the gift coupon management unit provides a limit amount input window with the order terminal device, sets a limit amount of money inputted by the order terminal device in the Moneycon, and sends the Moneycon to the reception terminal device.

3. The apparatus of claim 2, wherein the product information provision unit sends a product list that is able to be purchased using the Moneycon to the reception terminal device.

4. The apparatus of claim 2, wherein the settlement processing unit receives account information from the order terminal device before the reception terminal device selects the product using the gift coupon, performs settlement on the limit amount of money, and returns a difference between the limit amount of money and the selected product to the account of the order terminal device after the reception terminal device selects the product using the gift coupon.

5. The apparatus of claim 1, wherein the gift coupon management unit provides a quiz setting window and the product list to the order terminal device, if the gift coupon inputted by the order terminal device is a Quizcon, and sets quiz setting information in the Quizcon when the quiz setting information comprising a quiz, questionnaires, and products matched with the respective questionnaires in the quiz setting window is received from the order terminal device.

6. The apparatus of claim 5, wherein when any one of the questionnaire is selected by the reception terminal device, the product information provision unit sends product information matched with the selected questionnaire to the reception terminal device.

7. The apparatus of claim 5, wherein:
the settlement processing unit receives account information from the order terminal device and performs settlement on a highest price product of the products matched with the respective questionnaires, before the reception terminal device selects the product using the gift coupon, and
the reception terminal device selects the product using the gift coupon and returns a difference between the highest price product and the selected product to the account of the order terminal device.

8. The apparatus of claim 1, wherein if the gift coupon inputted by the order terminal device is a Choicecon, the gift coupon management unit provides a product list to the order terminal device, receives two or more products from the order terminal device, sets the two or more products in the Choicecon, and selects any one of the products set in the Choicecon and selected by the reception terminal device.

9. The apparatus of claim 8, wherein the settlement processing unit receives account information from the order terminal device before the reception terminal device selects the product using the gift coupon, performs settlement on a highest price product of the two or more products, and returns a difference between the highest price product and the selected product to the account of the order terminal device after the reception terminal device selects the product using the gift coupon.

10. A system for providing a recipient-selective mobile gift coupon, comprising:
an order terminal device which selects and inputs at least any one of a Moneycon, a Quizcon, and a Choicecon included in a gift coupon list and performs settlement on a product selected by a reception terminal device;
a gift coupon provision apparatus which provides the gift coupon list to the order terminal device, sends a gift coupon inputted by the order terminal device to the reception terminal device, and sends a Gifticon matched with the product selected by the reception terminal device using the gift coupon to the reception terminal device; and
the reception terminal device which selects the product using the gift coupon received from the gift coupon provision apparatus and receives the Gifticon matched with the selected product.

11. The system of claim 10, wherein:
if the gift coupon inputted by the order terminal device is a Moneycon, the gift coupon provision apparatus provides a limit amount input window to the order terminal device, sets a limit amount of money inputted by the order terminal device in the Moneycon, and sends a product list that is able to be purchased using the Moneycon to the reception terminal device,
if the gift coupon inputted by the order terminal device is a Quizcon, the gift coupon provision apparatus provides a quiz setting window and the product list to the order terminal device, sets quiz setting information in the Quizcon when the order terminal device inputs the quiz setting information, comprising a quiz, questionnaires, and products matched with the respective questionnaires, to the quiz setting window, and sends product information matched with a selected questionnaire to the reception terminal device when any one of the questionnaires is selected by the reception terminal device, and
if the gift coupon inputted by the order terminal device is a Choicecon, the gift coupon provision apparatus provides a product list to the order terminal device, receives two or more products from the order terminal device, and sets the two or more products in the Choicecon.

12. A method for providing a recipient-selective mobile gift coupon, the method comprising steps of:
(a) providing, by a gift coupon provision apparatus, an order terminal device with a gift coupon list comprising a Moneycon, a Quizcon, and a Choicecon;
(b) receiving at least any one gift coupon of the gift coupon list from the order terminal device;
(c) sending, by the gift coupon provision apparatus, the selected gift coupon, to a reception terminal device;
(d) receive a product selected by the reception terminal device using the gift coupon; and
(e) sending, by the gift coupon provision apparatus, a Gifticon matched with the selected product to the reception terminal device.

13. The method of claim 12, wherein:
the step (b) further comprises a step of providing, by the gift coupon provision apparatus, a limit amount input window to the order terminal device when the Moneycon is inputted, receiving a limit amount of money, and setting the limit amount of money in the Moneycon, and
the step (d) comprises steps of:
providing, by the gift coupon provision apparatus, the reception terminal device with a product list corresponding to the limit amount of money set in the Moneycon, and
selecting, by the reception terminal device, a product in the product list.

14. The method of claim 13, further comprising:
a step of receiving account information from the order terminal device and performing settlement on the limit amount of money prior to the step (d), and
a step of returning a difference between the limit amount of money and the product selected by the reception terminal device to the account of the order terminal device after the step (d).

15. The method of claim 12, wherein:
the step (b) further comprises a step of providing the order terminal device with a quiz setting window and the product list if a Quizcon is inputted and setting quiz setting information in the Quizcon if the order terminal device inputs the quiz setting information, comprising a quiz, questionnaires, and products matched with the respective questionnaires, to the quiz setting window, and
the step (d) comprises steps of:
receiving any one of the questionnaires from the reception terminal device and sending, by the gift coupon provision apparatus, product information matched with the selected questionnaire to the reception terminal device.

16. The method of claim 15, further comprising steps of:
receiving account information from the order terminal device and performing settlement on a highest price product of products matched with the respective questionnaires prior to the step (d), and
returning a difference between the highest price product and the product selected by the reception terminal device to the account of the order terminal device after the step (d).

17. The method of claim 12, wherein:
the step (b) further comprises a step of providing, by the gift coupon provision apparatus, a product list to the order terminal device if a Choicecon is selected, receiving two or more products, and setting the two or more products in the Choicecon, and
the step (d) comprises receiving one of the products set in the Choicecon from the reception terminal device.

18. The method of claim 17, further comprising steps of:
receiving account information from the order terminal device and performing settlement on a highest price product of the two or more products prior to the step (d), and
returning a difference between the highest price product and the product inputted by the reception terminal device to the account of the order terminal device after the step (d).

19. The method of claim 12, further comprising a steps of receiving, by the order terminal device, a product list from the gift coupon provision apparatus prior to the step (a) and selecting at least one product in the product list,
wherein the step (b) comprises steps of:
setting, by the order terminal device, information about one or more products selected from the product list in at least one gift coupon of the gift coupon list, and
receiving, by the gift coupon provision apparatus, a gift coupon in which the information about the products has been set from the order terminal device.
